(19) United States
(12) Patent Application Publication
(10) Pub. No.: US 2015/0114170 A1
(43) Pub. Date: Apr. 30, 2015

(54) MAIN SHAFT FOR A SLIDING CAM VALVE TRAIN

(71) Applicant: Schaeffler Technologies GmbH & Co. KG, Herzogenaurach (DE)

(72) Inventor: Ronny Gunnel, Puschendorf (DE)

(73) Assignee: SCHAEFFLER TECHNOLOGIES GMBH & CO. KG, Herzogenaurach (DE)

(21) Appl. No.: 14/404,761

(22) PCT Filed: Apr. 24, 2013
(86) PCT No.: PCT/EP2013/058467

§ 371 Date: Dec. 1, 2014

(30) Foreign Application Priority Data
Jun. 1, 2012 (DE) 102012209310.9

(51) Int. Cl. F01L 1/047; F16H 53/02

(52) U.S. Cl. CPC F01L 1/047; F16H 53/025
USPC 74/568 R

(57) ABSTRACT

A main shaft (1) for a sliding cam valve train is provided, with the main shaft (1) being provided, at least in the axial region of cam followers located thereon, with axial toothing (2) which is uniform over the length thereof, on which train there is placed, for each cam follower which is to be switched, a sliding cam piece (3) and, for each cam follower which is not to be switched, an axially non-displaceable cam piece (11) having inner toothing (4, 5) which is complementary in each case to the axial toothing (2) of the main shaft (1). To fix the cam piece (11) in the section of the inner toothing (5) thereof meshing with the axial toothing (2) of the main shaft (1), at least one axial locking ring (6) is provided.

### BACKGROUND

The invention relates to a main shaft for a sliding cam valve train, said main shaft being provided, at least in the axial region of cam followers located thereunder, with axial toothing which is uniform over the length thereof, on which shaft there is placed, for each cam follower which is to be switched, a sliding cam piece and, for each cam follower which is not to be switched, an axially non-displaceable cam piece, each cam piece having inner toothing, respectively, which is complementary to the axial toothing of the main shaft.

Such a main shaft can be found in the supplement “Technik Profi” in the magazine “Auto Motor und Sport,” issue 24/2011, p. 1, on the right. There, a sliding cam valve train is disclosed, by means of which, in a V8 engines, only a portion of the cylinders can be switched off. The cam followers, here, rocker arms, are each loaded in the lifting sense by a cam piece that is fixed on the main shaft in the axial direction and run by means of an inner toothing on the axial toothing of the main shaft. Bearing points, indicated here as longitudinal sections of the main shaft without toothing, have no teeth and are used for supporting said main shaft relative to a cylinder head.

Axial toothing of the main shaft that is also continuous in the area of the axially non-displaceable cam pieces contributes to economical manufacturability in large-scale series production. Thus it is clear that the axially non-displaceable cam pieces must be connected by suitable measures to the main shaft, wherein it can be seen that these cam pieces here contact a ring collar of the main shaft on one side.

In general, for locking the non-displaceable cam pieces, those skilled in the art think of fastening these cam pieces by a threaded connection or bolt connection that disadvantageously intersects the base circle of these pieces. Press-fit or shrink-fit connections or internal high-pressure forming (injection molding) are also conceivable. Depending on the structure, the cam pieces also might not be able to be pushed over the entire length of the main shaft from one of their ends, so that it is absolutely necessary to think of an assembled shape for the main shaft.

### SUMMARY

The objective is therefore to provide a main shaft as mentioned above on which the axially non-displaceable cam pieces are held very simply and securely, which provides cost benefits to the entire main shaft structure.

According to the invention, this objective is achieved in that, to fix the cam piece in the section of the inner toothing thereof meshing with the axial toothing of the main shaft, at least one axial locking ring is provided. Here it is especially preferred to provide a ring groove in the cam piece and in the main shaft, wherein a snap ring with, e.g., radially outward biasing sits in each of these ring grooves, bridging a ring surface between both components.

In this way, a main shaft of a sliding cam valve train is provided with non-displaceable cam pieces that are fixed in a very simple and secure manner.

According to a preferred improvement of the invention, the main shaft is formed integrally, that is, not assembled. This reduces its costs. It is clear that such a main shaft, if its cam pieces are to be pushed on from one end, must be provided without ring collars and with continuous, constant axial toothing, because at the other end there is, e.g., a flange for a camshaft adjustment device or a cam or the like for a fuel injection pump.

The main shaft can also be provided with completely continuous axial toothing, which is especially preferable with respect to production. In this case, tooth regions for bearing points can be either, e.g., wrapped with sleeves or ground at a later time.

A standard mass-produced article can be used as the snap ring. In particular, a polygon-shaped or round wire ring is conceivable. Ruptured (slotted) discs are also conceivable.

### BRIEF DESCRIPTION OF THE DRAWINGS

In the drawings:

FIG. 1 shows a three-dimensional view of a main shaft, and

FIG. 2 shows the axial locking ring as a detail.

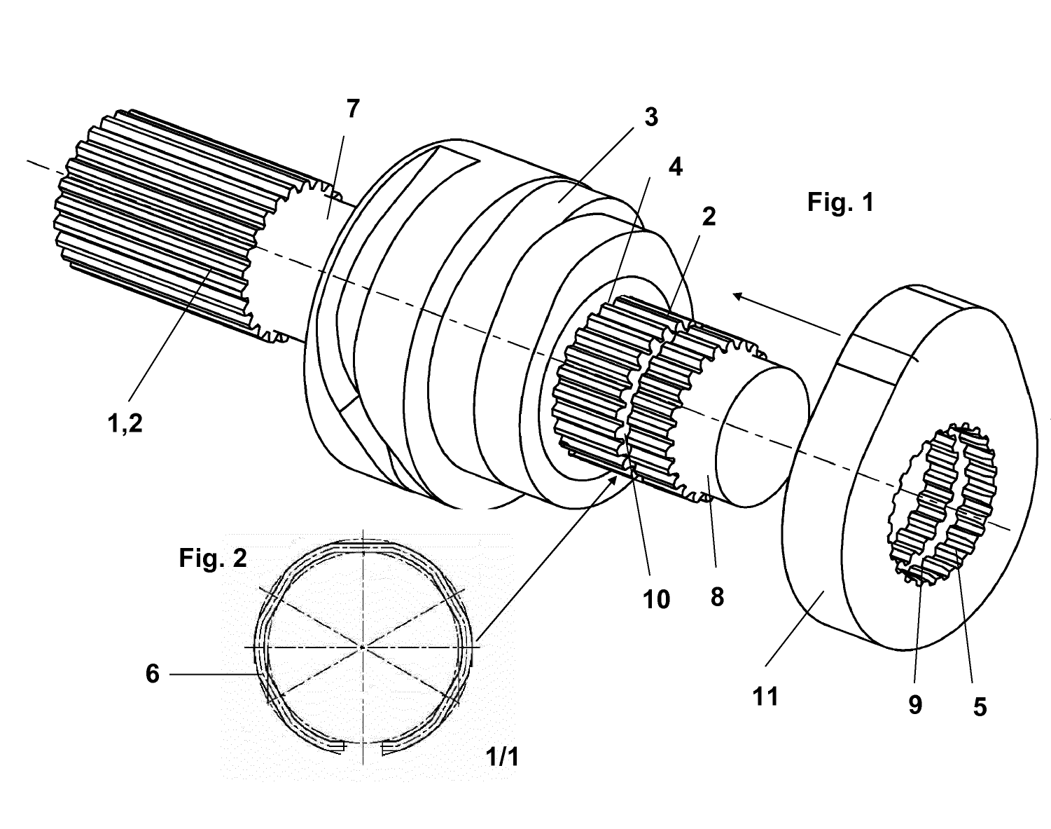

### DETAILED DESCRIPTION OF THE PREFERRED EMBODIMENTS

A section of an integrally formed main shaft 1 for a sliding cam valve train is shown. This main shaft 1 has uniform axial toothing 2 in a schematically shown bearing region 7 and an end piece 8, wherein, e.g., a camshaft adjustment device can be flanged onto said end piece 8. In the axial region of a not-shown, switchable cam follower lying underneath, a sliding cam piece 3 is shown that is displaceable in the axial direction on the axial toothing 2 of the main shaft 1 by means of its inner toothing 4.

In the section of a cam follower not to be switched, an axially non-displaceable cam piece 11 shown on the right is illustrated in an exploded view. This has inner toothing 5 that is also complementary to the axial toothing 2 of the main shaft 1. In the region of the inner toothing 5 of the cam piece 11 there is a ring groove 9 that lies radially opposite a ring groove 10 in the axial toothing 2 of the main shaft 1. In these ring grooves 9, 10 there is an axial locking ring 6, shown here as a polygon ring, with radially outward biasing (see also FIG. 2). By means of this axial locking ring 6, the cam piece 11 is fixed so that it is not displaceable axially on the main shaft 1.

### LIST OF REFERENCE NUMBERS

1) Main shaft
2) Axial toothing
3) Sliding cam piece
4) Inner toothing of sliding cam piece
5) Inner toothing of cam piece
6) Axial locking ring
7) Bearing region
8) End piece
9) Ring groove of cam piece
10) Ring groove of main shaft
11) Cam piece

1. A main shaft assembly for a sliding cam valve train, comprising a main shaft including, at least in an axial region of cam followers located thereon, axial toothing which is uniform over a length thereof, a sliding cam piece located on said shaft for each cam follower which is to be switched, and an axially non-displaceable cam piece located on said shaft for each cam follower which is not to be switched, each of the sliding cam pieces and the axially non-displaceable cam pieces having inner toothing, respectively, which is complementary to the axial toothing of the main shaft, and at least one axial locking ring connected to the main shaft to fix the axially non-displaceable cam piece in a section of the inner toothing thereof meshing with the axial toothing of the main shaft.

2. The main shaft assembly according to claim 1, wherein the main shaft is formed integrally in one piece.

3. The main shaft assembly according to claim 1, wherein the axial toothing of the main shaft is essentially continuous in an axial direction either a) up to smooth-walled bearing regions or b) up to the smooth-walled bearing regions and up to at least one of its end pieces.

4. The main shaft assembly according to claim 1, further comprising a bearing flange for attaching a camshaft adjustment device applied to a non-toothed end piece of the main shaft.

5. The main shaft assembly according to claim 1, wherein, a ring groove is formed in a section of the inner toothing of the cam piece, said ring groove being opposite a ring groove in a radial direction in the axial toothing of the main shaft, with the axial locking ring sitting in said ring grooves.

6. The main shaft assembly according to claim 5, wherein the axial locking ring is a snap ring that extends, when installed, either with outward radial biasing in the ring groove of the cam piece or with inward radial biasing in the ring groove of the main shaft.
